(19) United States
(12) Patent Application Publication
(10) Pub. No.: US 2005/0048274 A1
(43) Pub. Date: Mar. 3, 2005

(54) Production of nanowebs by an electrostatic spinning apparatus and method

(76) Inventors: John F. Rabolt, Greenville, DE (US); Darrln J. Pochan, Allentown, PA (US); Jean S. Stephens, Elkton, MD (US)

Correspondence Address: CONNOLLY BOVE LODGE & HUTZ LLP, SUITE 800, 1990 M STREET NW, WASHINGTON, DC, 20036-3425, US

(21) Appl. No.: 10/406,596

(22) Filed: Aug. 26, 2003

(51) Int. Cl. B32B 3/26

(52) U.S. Cl. 428/304.4; 205/76; 205/77; 428/903; 442/340; 442/351; 442/414

(57) ABSTRACT

A method for producing a webbed fibrillar material includes providing a polymer material including a solvent; injecting the polymer material into an electric field toward an electrically charged target; controlling at least one process parameter to produce the webbed fibrillar material having one or more desired characteristics; and collecting the webbed fibrillar material from the target. The process parameter may be selected from the group consisting of an electric field strength, a temperature, a solution viscosity of the polymer material, a distance between an injection point and the target, a solvent type, a relative concentration of the solvent and polymer material, a molecular weight of the molecules of the polymer material, an environmental temperature, an environmental humidity, and a drying time of the injected polymer material.

### GOVERNMENT LICENSE RIGHTS

The United States Government has rights in this invention as provided for by National Science Foundation (NSF) Grant No. DMR-9812088 and Department of Energy Grant No. DE-FG02-99-ER45794.

### TECHNICAL FIELD OF THE INVENTION

This invention relates generally to an apparatus and method adapted for an electrospinning technique to shape materials, e.g., polymer materials, into a web having fibers with unique surface features. These novel features lead to, for example, a significant increase in the ratio of the surface area of the spun fibers to their volume, thus making them desirable for applications in filters, fuel cells, and tissue-engineered devices, for example.

This invention further relates to an apparatus and method for electrospinning biomaterials or polymers, including electroluminescent, thermally conducting, or electrically conducting polymers, for example, into an interconnected fibrillar web network having a large ratio of surface area to volume, with individual fibers having diameters ranging from 8-100 nm, for example.

### BACKGROUND OF THE INVENTION

Conventional fiber spinning methods may require tens or even hundreds of pounds of starting materials. Further, specialty fibers such as bioderived, electroactive, and polypeptide fibers can conventionally be produced only in small quantities. Production of large quantities of fibers and/or non-woven cloth or mats is currently difficult, if not possible, due to the low throughput of the syringe used in conventional techniques. To overcome the problem of low throughput with the use of a syringe, a spinnerette or “shower head” configuration has been used, but only to produce multiple single fibers.

One advantage of a technique known as “electrospinning” is that only a small amount of starting material is required to produce fibers, e.g., as little as 50 mg, in contrast to the tens or hundreds of pounds required conventionally to produce fibers without electrospinning. One advantage of using small amounts of starting materials in electrospinning is that it makes production of specialty polymer fibers possible, such as bioderived, electroactive, and polypeptide fibers, for example.

The forming of polymers into uniform shapes at different length scales ranging from microns to nanometers continues to be a significant challenge to the scientific and industrial/technical communities. Of further importance in this regard is the development of characterization techniques to explore and optimize structure-property relationships in these extremely short fiber length regimes.

Producing an interconnected fibrillar network, or “web”, having fibers of relatively small diameter, e.g., 100 nm, or less than approximately one-thousandth the width of a human hair, and controlling the development of microstructure as the fiber webs are formed, is currently not available. Fiber webs having such a microstructure could be used as tissue scaffold materials, for example. Further, it would be useful if the small fibers in the web allowed enhanced cell interactions through a tailoring of their surface properties, and if the fibers were also small enough to biodegrade rapidly within the body.

Another challenge under current technological constraints is to produce uniform polymer micro or nanofibers that could comprise protein polymers and could be made, for example, by calendaring, i.e. a process to bind fibers together at interconnecting points, into a “bioactive” fabric mat for membrane applications in fuel cells, sensing and purification, as just a few examples. Such binding of fibers adds structural integrity to the resulting web.

The ability to understand, and then control structural development and surface morphology in fibers at both the micro- and nanoscale would allow the ability to produce oriented multi component fibers for biomaterial applications, such as tissue engineering and scaffolding; for structural applications requiring high modulus fibers and webs for construction of optical or radio reflector supports in low gravity environments; or for photonic applications, e.g., fiber bio-optics.

The creation of submicron structures by spontaneous assembly has been reported to occur in colloidal crystals, phase separated block copolymers, bio-inspired materials (S Layers) and, most recently, in polymer films. In all cases, however, ordered arrays of nanoscale features are produced either by the packing of nano-sized objects (e.g. spheres), or by molecular recognition, e.g. thermodynamically driven phase separation, but not by formation of a web.

Electrospun mats have been made in a variety of shapes, for example, shunts, however the fiber diameters are larger than that desired for some applications. The production of these structures does not simultaneously form nanowebs, and therefore do not result in a structure having the desired ultrahigh ratio of surface area to volume.

These conventional approaches present problems, not only by the required complex processing techniques and low yield, but also in the degradation of fibers due to heat treatment, or other processes, which ultimately affect the mechanical integrity of the mats.

Another related conventional method to induce a submicron porous texture on polymer fibers, as they are formed, uses an electrostatic spinning technique, i.e., “electrospinning”, to spontaneously form fibers having micro- and nanopores.

These micro- and nanopores are formed when polymers, such as polystyrene (PS), are electrospun from volatile solvents such as tetrahydrofuran (THF), carbon disulfide (CS2), or acetone/cyclohexane. The rapid evaporation of solvent in the charged polymer liquid jet as the fiber is formed and traverses the distance (20-35 cm) towards a grounded target leaves individual fibers with pores having dimensions that vary from 20-1000 nm. The density and size of the pores on the fiber surface, as illustrated in FIG. 2, depends on the polymer/solvent system used, and the processing protocol.

However, spontaneous formation of micro/nanofibrillar webs, i.e., micro/nanofibers which are arranged in an interconnected web has not been achieved using conventional techniques.

What is needed, then, is a relatively inexpensive apparatus and easy method for producing micro or nanofibrillar web structures having the desired high ratio of surface area to volume.

What is further needed is an electrospinning setup and method to produce a large throughput of polymer or biomaterial fibers having relatively small diameters arranged in an interconnected fibrillar web network.

### SUMMARY OF THE INVENTION

The present invention solves many of the aforementioned problems of providing an apparatus and method for producing micro or nanofibers web structures having the desired high ratio of surface area to volume, and for an electrospinning setup and method to produce a large throughput of polymer or biomaterial fibers having relatively small diameters arranged in an interconnected fibrillar web network.

With this apparatus and method, it is now possible to create two distinct features, one having micro and nanoporous fibers, and the other having ultra fine fibers. Processing parameters are relatively easy to control, therefore simplifying production of the fibers in a spontaneous manner.

Further, the apparatus and method of this invention has application to tissue scaffolds, membranes for filtration, fuel cell applications, and porous fabric, for example.

### BRIEF DESCRIPTION OF THE DRAWINGS

The features and advantages of the invention will be more readily understood upon consideration of the following detailed description of the invention, taken in conjunction with the accompanying drawings in which:

FIG. 1A provides a schematic diagram of an electrospinning apparatus used in this invention;

FIG. 1B provides a picture of an exemplary embodiment of the apparatus of the invention;

FIG. 2 shows a Field Emission Scanning Electron Microscope (FE-SEM) picture of conventional porous polystyrene (PS) fibers developed under spinning conditions including 35 wt % PS in THF, 35 cm gap, 10 kV, with a grounded target;

FIG. 3 shows a picture of a result of using the process of the present invention which is an electrospun nanoweb of collagen developed under spinning conditions including 20 wt % type IV collagen in formic acid (70% formic solution), 10 cm gap, 7 kV, with a grounded target; and

FIG. 4 shows a picture of an electrospun nylon nanoweb developed under spinning conditions including 30 wt % nylon 6 in formic acid (molecular weight of 66,000 g/mole), 15 cm gap, 7 kV, with a grounded target.

### DESCRIPTION OF PREFERRED EMBODIMENTS

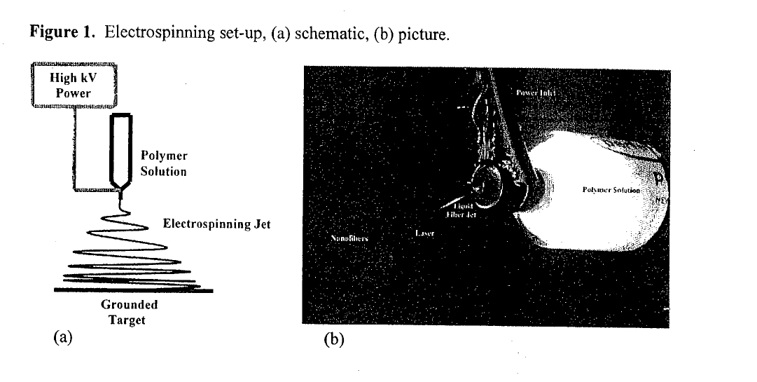

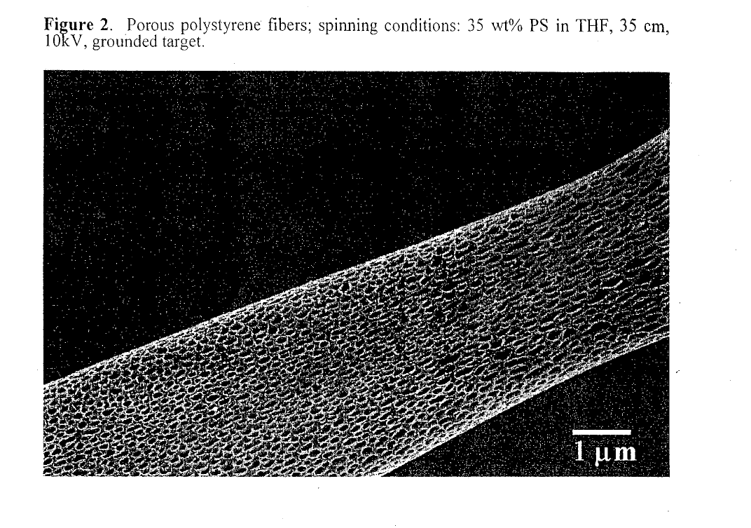

We have produced polymer fibers and interconnected fibrillar web network at the micro and nanometer length scales by electrospinning, a process that is derived from the classical technique of electrospraying. In contrast to melt spinning, electrospinning uses a high voltage to create an electrically charged liquid jet of polymer solution. Electrical forces at the surface of the polymer solution (or a low viscosity melt) overcome the surface tension of the solution, and an electrically charged jet, 50-100 μm in diameter, for example, is emitted, as shown in FIG. 1. In FIG. 1, the laser beam is used to characterize the orientation of fibers.

As the jet is accelerated towards a grounded target by electrical forces, the solvent evaporates and the charge is concentrated on the solid fiber eventually causing it to reach an instability point where the electrospinning jet begins to splay, producing submicron diameter fibers (bundles of nanofibers are also evident on lower left of FIG. 1B). The fibers produced during the electrospinning process achieve truly nanoscale dimensions, with diameters ranging from 10 nm to 10 μm. For comparison, traditional textile processes produce fibers with diameters of 5-200 μm.

One advantage of electrospinning is that it uses minute quantities, e.g., 50 mg of polymer or biopolymer in solution to form a fiber, and the processing conditions are preferably tailored to produce uniform fibers at diameters that range over three orders of magnitude.

These processing parameters include the applied voltage, solution viscosity, the distance between the syringe tip and the target, solvent type, the relative concentration of the solvent and material, e.g., polymer material, the molecular weight of the molecules, temperature, humidity, and drying time, for example. A combination of two or more of these processing parameters may be used to achieve the desired results, e.g., controlling the density of the pores in the individual fibers, as well as the structural features of the spontaneously formed interconnected fibrillar web network. In other words, the choice of processing protocol parameters can be used to fine-tune the percentage of ultrafine fibers with respect to the amount of nanoporous fibers present in the spontaneously formed web.

Under varying processing conditions, i.e., varying one or more of the process parameters indicated above, electrospinning techniques could be used to form polymer webs on the micro and nanoscale. These webs are composed of micro- and nanofibrils that range in diameter from 8 nm-1 μm, for example.

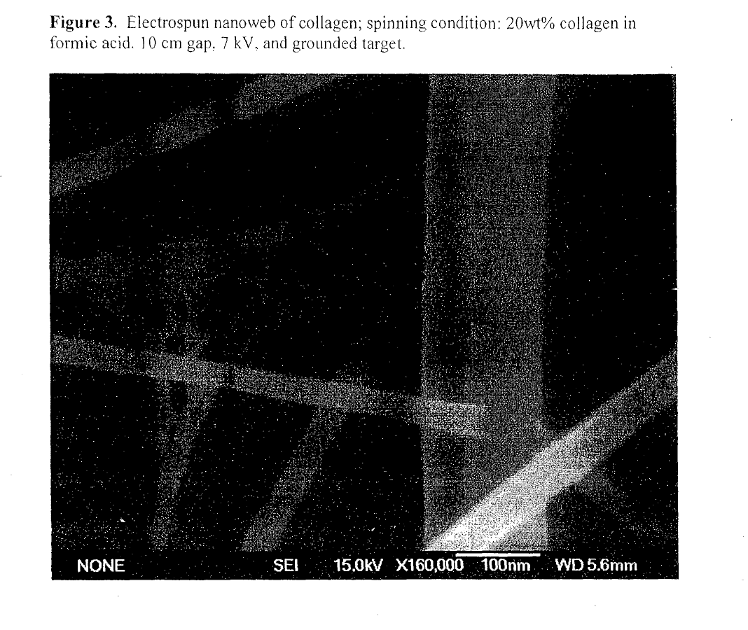

An example of a “nanoweb” is shown in FIG. 3. In this case, the nanoweb was electrospun from a solution of collagen in formic acid. Some of the smallest nanofibrils in this web are 8 nm in diameter. Considering that collagen is composed of a polypeptide triple helix whose diameter is approximately 2 nm, this would indicate that the nanofibrils are composed of four triple helices if they are aligned in a parallel arrangement along the nanofibril long axis.

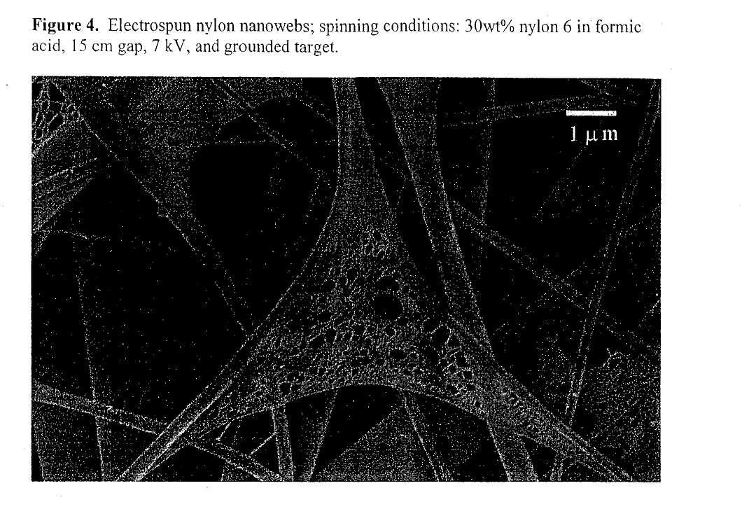

Another example of nanoweb is shown in FIG. 4. In this case poly(caprolactam), belonging to the polyamide family, was electrospun from formic acid. The amount of surface area present in these nanowebs due to the fibril size and their density can exceed 1200 m²/g, making them extremely useful when electrospun into membranes for cell adhesion, filter and fuel cell applications. The production of nanowebs by the electrospinning process will also occur in many other polymers.

Use of an arrangement similar to FIG. 1A, which includes a spinnerette or “shower head” configuration, would further enhance the web-forming capabilities over the relatively simple syringe approach.

In another embodiment, an electric field focusing apparatus, e.g., a hexapole device, may be placed between the syringe tip and the target to control the trajectory of the electrospun fiber and to control the fibrillar network structure of the spontaneously formed web. Such control of the trajectory and electric field may be performed via an appropriately programmed microprocessor.

In yet another embodiment, the syringe tip may be mechanized to control the trajectory and deposition direction of the fibers and the resulting fibrillar network structure of the spontaneously formed web. Such control may also be performed by a microprocessor.

In another embodiment, the syringe may have a non-circular aperture, e.g., a rectangular slit, or may have multiple holes arranged in an array pattern.

### Industrial Applicability

The method and apparatus of the invention has a wide variety of practical applications, including, but not limited to, the following:
A method and process to produce and shape ultrafine polymer fibers with diameters as small as 8-100 nanometers into complex two-dimensional and three-dimensional structures containing an intertwined fibrillar network;
A method and process to produce and shape ultrafine polymer fibers with diameters as small as 8-100 nanometers into complex two dimensional and three dimensional structures containing an intertwined fibrillar network with the application of surface modifying agents (e.g., coatings) to enhance adhesion;
A method and process to produce and shape ultrafine polymer fibers with diameters as small as 8-100 nanometers into complex two dimensional and three dimensional structures containing an intertwined fibrillar network with the application of surface modifying agents (e.g., coatings) to enhance lubrication;
A method and process to produce and shape ultrafine polymer fibers with diameters as small as 8-100 nanometers into complex two dimensional and three dimensional structures containing an intertwined fibrillar network with the application of surface modifying agents (e.g., coatings) to enhance or reduce wetting;
A method and process to produce and shape ultrafine biomaterial (either originating from the body, derived from biology (bioderived), inspired by biology (bioinspired), chemically or physically synthesized) fibers with diameters as small as 8-100 nanometers into complex two dimensional and three dimensional structures containing a complex intertwined fibrillar network with the application of surface modifying agents (e.g., coatings) to enhance or prevent cell adhesion;
A method and process to produce and shape ultrafine biomaterial (either originating from the body, derived from biology (bioderived), inspired by biology (bioinspired), chemically or physically synthesized) fibers with diameters as small as 8-100 nanometers into complex two dimensional and three dimensional structures containing a complex intertwined fibrillar network with the application of surface modifying agents (e.g., coatings) to enhance or prevent the adhesion of bacteria or viruses;
A method to produce complex intertwined 2-D and 3-D shapes composed of ultrafine fibers at varying densities where a significant increase (or decrease) in the fiber surface area relative to its volume can occur;
A method to produce complex intertwined 2-D and 3-D shapes composed of ultrafine fibers at varying densities where a significant increase (or decrease) in the fiber surface area relative to its volume can occur with the application of surface modifying agents (e.g., coatings) to change the surface properties;
A method to produce and shape ultrafine collagen fibers with diameters as small as 8-100 nanometers into complex two-dimensional and three-dimensional structures containing an intertwined fibrillar network;
A method to produce and shape ultrafine collagen fibers with diameters as small as 8-100 nanometers into complex two dimensional and three dimensional structures containing an intertwined fibrillar network for applications including, but not limited to, tissue engineered scaffolds (for bone regeneration, for artificial organs, for construction of arteries, etc.) and wound repair;
A method to produce complex intertwined 2-D and 3-D shapes and webs composed of ultrafine fibers at varying densities where a significant increase in the fiber surface area relative to its volume occurs for applications including, but not limited to, water filtration and fuel cell membranes;
A method to produce and shape ultrafine oriented polymer fibers with diameters as small as 8-100 nanometers into complex two dimensional and three dimensional structures containing an intertwined fibrillar network for applications requiring anisotropic mechanical properties;
A method to produce and shape ultrafine oriented polymer fibers with diameters as small as 8-100 nanometers into complex two dimensional and three dimensional structures containing an intertwined fibrillar network for applications requiring isotropic mechanical properties;
A method to produce and shape ultrafine oriented conducting (metal filled or intrinsically electrically conducting) polymer fibers with diameters as small as 8-100 nanometers into complex two dimensional and three dimensional structures containing an intertwined fibrillar network for applications requiring anisotropic electrical properties;
A method to produce and shape ultrafine oriented conducting (metal filled or intrinsically electrically conducting) polymer fibers with diameters as small as 8-100 nanometers into complex two dimensional and three dimensional structures containing an intertwined fibrillar network for applications requiring isotropic electrical properties;
A method to produce and shape ultrafine oriented semiconductive (semiconductor filled or intrinsically electrically semiconductive due to chemical or physical structure) polymer fibers with diameters as small as 8-100 nanometers into complex two dimensional and three dimensional structures containing an intertwined fibrillar network for applications requiring isotropic semiconductive electrical properties;
A method to produce and shape ultrafine oriented semiconductive (semiconductor filled or intrinsically electrically semiconductive due to chemical or physical structure) polymer fibers with diameters as small as 8-100 nanometers into complex two dimensional and three dimensional structures containing an intertwined fibrillar network for applications requiring anisotropic semiconducting electrical properties;
A method to produce and shape ultrafine oriented thermally conducting (metal filled or intrinsically thermally conducting) polymer fibers with diameters as small as 8-100 nanometers into complex two dimensional and three dimensional structures containing an intertwined fibrillar network for applications requiring isotropic thermal properties;
A method to produce and shape ultrafine oriented (or non-oriented) thermally conducting (metal filled or intrinsically thermally conducting) polymer fibers with diameters as small as 8-100 nanometers into complex two dimensional and three dimensional structures containing an intertwined fibrillar network for applications requiring anisotropic (or isotropic) thermal properties;
A method to produce and shape ultrafine optically transmissive polymer fibers with diameters as small as 8-100 nanometers into complex two dimensional and three dimensional structures containing an intertwined fibrillar network for applications requiring optical transmission, e.g., coupling of laser or other light through finely dimensioned fiber optics.

The disclosure above shows and describes only the preferred embodiments of the invention, but it is to be understood that the invention is capable of use in various other combinations, modifications, and environments, and is capable of changes or modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A method for producing a webbed fibrillar material, the method comprising:
providing a polymer material including a solvent;
injecting the polymer material into an electric field toward an electrically charged target;
controlling at least one process parameter to produce the webbed fibrillar material having one or more desired characteristics; and
collecting the webbed fibrillar material from the target,
wherein the at least one process parameter is selected from the group consisting of an electric field strength, a temperature, a solution viscosity of the polymer material, a distance between an injection point and the target, a solvent type, a relative concentration of the solvent and polymer material, a molecular weight of the molecules of the polymer material, an environmental temperature, an environmental humidity, and a drying time of the injected polymer material.

2. The method of claim 1, wherein said controlling the at least one process parameter is carried out to provide a controlled density of pores in individual fibers of the webbed fibrillar material.

3. The method of claim 1, wherein said controlling controls a ratio of an amount of ultrafine fibers to an amount of nanoporous fibers present in the webbed fibrillar material.

4. A webbed fibrillar material, comprising a plurality of polymer fibers arranged in a mat, wherein the plurality of polymer fibers include both ultrafine fibers and nanoporous fibers.
